(19) United States
(12) Patent Application Publication
(10) Pub. No.: US 2022/0091851 A1
(43) Pub. Date: Mar. 24, 2022

(54) System, Apparatus And Methods For Register Hardening Via A Micro-Operation

(71) Applicant: Intel Corporation, Santa Clara, CA (US)

(72) Inventors: FANGFEI LIU, Hillsboro, OR (US); ALAA ALAMELDEEN, Hillsboro, OR (US); ABHISHEK BASAK, Bothell, WA (US); SCOTT CONSTABLE, Portland, OR (US); FRANCIS MCKEEN, Portland, OR (US); JOSEPH NUZMAN, Haifa (IL); CARLOS ROZAS, Portland, OR (US); THOMAS UNTERLUGGAUER, Hillsboro, OR (US); XIANG ZOU, Portland, OR (US)

(21) Appl. No.: 17/029,335

(22) Filed: Sep. 23, 2020

(51) Int. Cl. G06F 9/38; G06F 9/48; G06F 21/54; G06F 9/30

(52) U.S. Cl. CPC G06F 9/3842; G06F 9/4881; G06F 2221/034; G06F 9/30145; G06F 9/30043; G06F 21/54

(57) ABSTRACT

In one embodiment, a processor includes: a decode circuit to decode a load instruction that is to load an operand to a destination register, the decode circuit to generate at least one fencing micro-operation (μop) associated with the destination register; and a scheduler circuit coupled to the decode circuit. The scheduler circuit is to prevent speculative execution of one or more instructions that consume the operand in response to the at least one fencing μop. Other embodiments are described and claimed.

### TECHNICAL FIELD

Embodiments relate to providing protection against transient execution attacks in a processor.

### BACKGROUND

The recent disclosure of Spectre and Meltdown attacks have opened a new attack surface on processors called transient execution attacks. Fundamentally, there are two types of transient execution attacks: 1) attacks exploiting speculative data forwarding on faults; and 2) attacks exploiting the speculation mechanism of hardware predictors, such as branch direction predictor, branch target predictor, memory disambiguation predictor, etc. Attacks that exploit speculative data forwarding on faults can be fixed in hardware without any performance hit. However, attacks that exploit hardware speculation mechanisms are hard to prevent, because they strike the fundamental computer architecture design principles, such that any mitigation is likely to have a performance hit.

### BRIEF DESCRIPTION OF THE DRAWINGS

FIG. 1A is a block diagram of a portion of a processor core in accordance with an embodiment.

FIG. 1B is a block diagram of a processor in accordance with an embodiment.

FIG. 2 is a flow diagram of a method in accordance with an embodiment.

FIG. 3 is a flow diagram of a method in accordance with another embodiment.

FIGS. 4A and 4B are flow diagrams of a method in accordance with yet another embodiment.

FIGS. 5A-5C are block diagrams of a dependency structure in accordance with an embodiment.

FIG. 6A is a block diagram illustrating both an exemplary in-order pipeline and an exemplary register renaming, out-of-order issue/execution pipeline according to embodiments of the invention.

FIG. 6B is a block diagram illustrating both an exemplary embodiment of an in-order architecture core and an exemplary register renaming, out-of-order issue/execution architecture core to be included in a processor according to embodiments of the invention.

FIG. 7 is a block diagram of a processor that may have more than one core, may have an integrated memory controller, and may have integrated graphics according to embodiments of the invention.

FIG. 8 shows a block diagram of a system in accordance with one embodiment of the present invention.

FIG. 9 is a block diagram of a first more specific exemplary system in accordance with an embodiment of the present invention.

FIG. 10 is a block diagram of a second more specific exemplary system in accordance with an embodiment of the present invention.

FIG. 11 is a block diagram of a system-on-chip (SoC) in accordance with an embodiment of the present invention.

FIG. 12 is a block diagram contrasting the use of a software instruction converter to convert binary instructions in a source instruction set to binary instructions in a target instruction set according to embodiments of the invention.

### DETAILED DESCRIPTION

In various embodiments, a processor is configured to provide comprehensive microarchitecture-level mitigation for certain transient execution attacks. More particularly, embodiments may protect against attacks exploiting branch predictors as a speculation mechanism, and focus on preventing a universal read gadget problem.

In embodiments, a fencing micro-operation (μop) is provided that can prevent data in a register from propagating until one or more previous branches are correctly resolved. The fencing μop can be added to a load instruction to prevent the loaded data from being consumed until all previous branches before the load are correctly resolved, i.e., the load is no longer speculative. In certain implementations, an instruction set architecture (ISA) can include an explicit instruction, e.g., a user-level instruction, so that software can explicitly fence data in a register.

With embodiments, performance overhead of a hardware load hardening mitigation strategy can be reduced with low hardware complexity, by allowing a load instruction to complete. This hardware load hardening mitigation strategy is a comprehensive solution to mitigate all speculation-based attacks, which not only can mitigate against known attacks, but also can mitigate yet unknown speculation-based attacks.

In general, a speculative side channel attack includes four components: a speculation primitive, a windowing gadget, a disclosure gadget and a disclosure primitive. The speculation primitive is any speculation mechanism that causes a processor to enter speculative execution and when the speculation turns out to be wrong, a pipeline is squashed. Embodiments may protect speculation due to hardware predictors, and in particular branch predictors. A windowing gadget is the instruction that creates a sufficient amount of speculative execution time so that it takes a sufficient amount of time for the speculation to be resolved. For example, if a branch condition depends on a load that misses in the cache, the uncached load is a windowing gadget for the conditional branch.

In turn, the disclosure gadget contains the instructions that actually leak information through side channels during the speculative execution, namely an access instruction that reads the secret data and a transmit instruction that encodes secret data into micro-architectural states, such as caches and branch predictors. Finally, the disclosure primitive is the attack component that an attacker uses to receive the information that was transmitted through the side channel.

In an embodiment, a hardware load hardening (HLH) mitigation strategy focuses on preventing the universal read gadget problem, where both access instruction and transmit instruction are executed speculatively, and the access instruction may have unauthorized memory access to an arbitrary memory location. HLH addresses the universal read gadget problem by ensuring that data read by a speculative load is not consumed speculatively, and there is no information leakage through a speculative side channel, no matter what disclosure primitive it is.

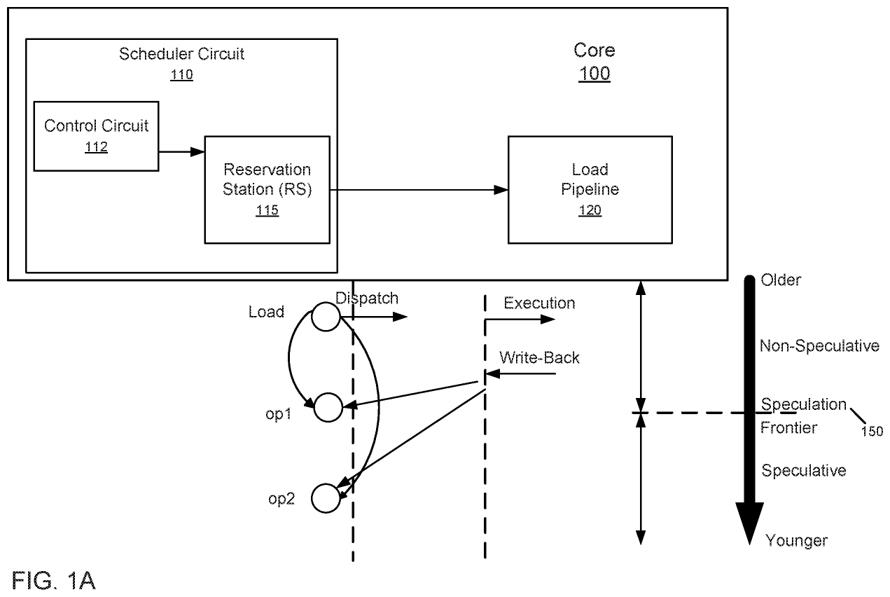

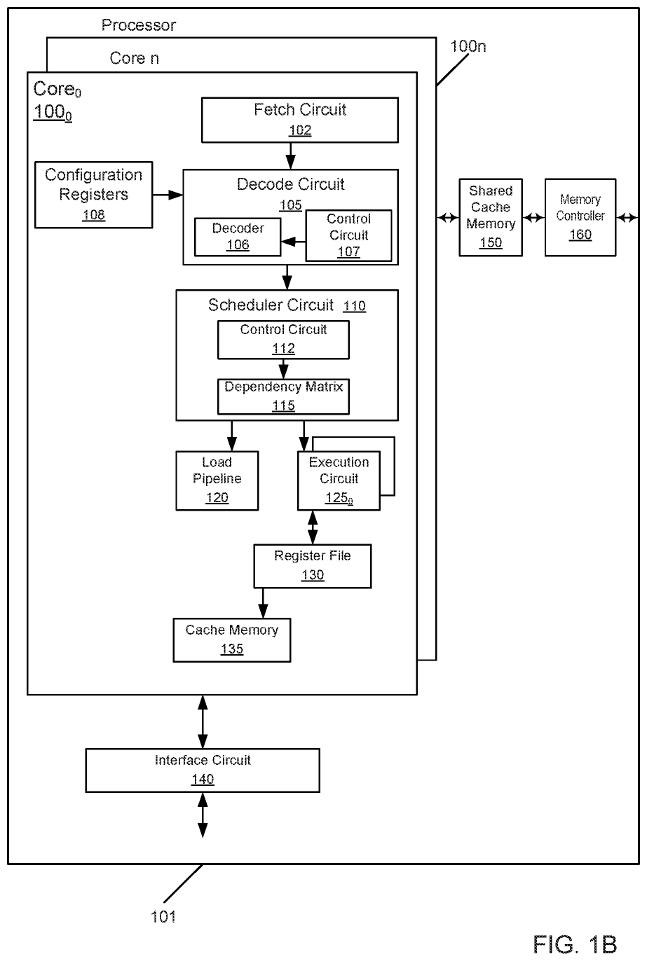

Referring now to FIG. 1A, shown is a block diagram of a portion of a processor core in accordance with an embodiment. As shown in FIG. 1A, in the high level shown core 100 includes a scheduler circuit 110 that in turn includes a control circuit 112 and a reservation station (RS) 115, which may include a dependency structure such as a dependency matrix, details of which are described further below. As seen, scheduler circuit 110 dispatches instructions for execution in execution circuitry, including a load pipeline 120. With hardware load hardening in accordance with an embodiment, control circuit 112 may cause scheduler circuit 110 to delay the consumption of loaded data until the load becomes non-speculative.

FIG. 1A further shows a flow of operations within core 100. As seen, a load is dispatched and executed speculatively, and becomes non-speculative when its age is older than a speculation frontier 150, i.e., the load is no longer squashable due to branch mis-prediction and its behavior is architectural. Speculation frontier 150 is determined by the speculation mechanisms considered. In the context of a branch predictor, speculation frontier 150 represents the oldest unresolved branch in the processor.

It is possible to delay the consumption of loaded data at the source, by delaying the load itself, such as by delaying the dispatch of the load at RS 115. However, this may incur a large performance overhead.

Thus in embodiments, consumption of loaded data may be delayed at the destination, such as by delaying direct consumers of the load (e.g., op1 and op2 in FIG. 1A). With this approach, a load can complete and write back, but the dispatch of its direct consumers is delayed until the load becomes non-speculative. Since the load can complete write back, the dispatch of the load's consumers experiences shorter delay when the load becomes non-speculative, and thus better performance may be realized.

Referring now to FIG. 1B, shown is a block diagram of a processor in accordance with an embodiment. In FIG. 1B, processor 101 is shown at a high level to illustrate components involved in performing register hardening in accordance with an embodiment. In the embodiment shown, processor 101 is a multicore processor including a plurality of cores 100₀-100ₙ. Cores 100 further couple to a shared cache memory 150 and a memory controller 160, which acts as an interface to a system memory (not shown in FIG. 1B). Still further, cores 100 couple via an interface circuit 140 to other devices of a system, such as one or more peripheral devices.

Still referring to FIG. 1B, various components of core 100₀ involved in performing hardware load hardening via fencing mechanisms are shown. As illustrated, a fetch circuit 102 is configured to fetch instructions. In turn, fetched instructions are provided to a decode circuit 105. As illustrated, decode circuit 105 includes a decoder 106 which may decode incoming instructions, e.g., macro-instructions, into one or more μops. Such decoding may be performed under control of a control circuit 107. In embodiments herein, control circuit 107, when enabled according to configuration information stored in one or more configuration registers 108, may cause decoder 106 to decode a load instruction into one or more load μops and an additional fencing μop as described herein. In turn, the decoded μops are provided to a scheduler circuit 110. As illustrated, scheduler circuit 110 includes a control circuit 112. In embodiments herein in response to a load μop, control circuit 112 may add additional dependency indicators within one or more entries of a dependency matrix 115. Dependency matrix 115 may be implemented as part of a reservation station, in an embodiment.

As further illustrated in FIG. 1B, scheduler circuit 110 may issue scheduled μops, when ready for execution, to one of multiple execution circuits 125₀₋ₙ, such as various arithmetic logic units, including integer and floating point units. Results of operations performed in execution units 125 may be stored in a register file 130. In addition, scheduler circuit 110 may send load μops to a load pipeline 120, which may access a memory hierarchy to obtain requested load data. As shown, this memory hierarchy may include a core-included cache memory 135 such as one or more levels of a cache memory, in addition to shared cache memory 150 and a system memory (not shown in FIG. 1B). With embodiments herein, note that scheduler circuit 110 does not issue dependent μops for execution until source data used by such dependent μops becomes non-speculative.

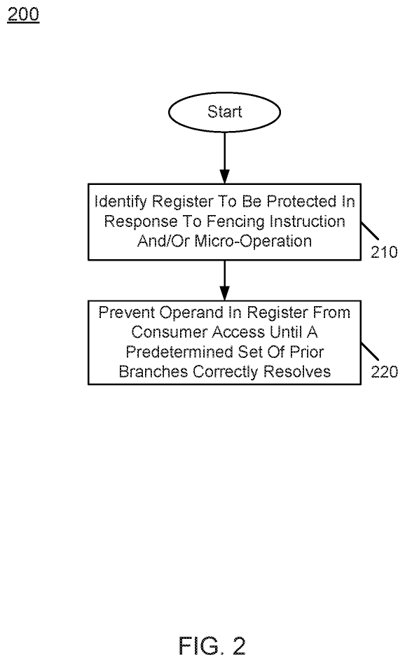

Referring now to FIG. 2, shown is a flow diagram of a method in accordance with an embodiment. As shown in FIG. 2, method 200 is a high level method for performing hardware load hardening using one or more fencing μops as described herein. Method 200 may be performed by control circuitry within a processor, including such control circuitry as may be present in a decode circuit and a scheduler circuit. As such, method 200 may be performed by hardware circuitry, firmware, software and/or combinations thereof. In one particular embodiment, hardware circuitry within decode circuit 105 and scheduler circuit 110 of FIG. 1B may perform method 200.

As illustrated, method 200 begins at block 210 by identifying a register to be protected in response to a fencing instruction and/or a fencing μop. Such identification may be performed by a decoder circuit that receives an incoming fencing instruction (or a load instruction that is to be hardened). Next at block 220 the identified register may be protected such that its contents are prevented from being accessed speculatively. That is, a scheduler circuit may prevent one or more consumers of this register from accessing the register until the contents of this register (e.g., a given operand) becomes non-speculative, such as may occur when a fencing μop reaches a speculation frontier. This speculation frontier itself may occur when a set of predetermined prior branches (e.g., all prior branches or one or more predefined prior branches) resolves correctly.

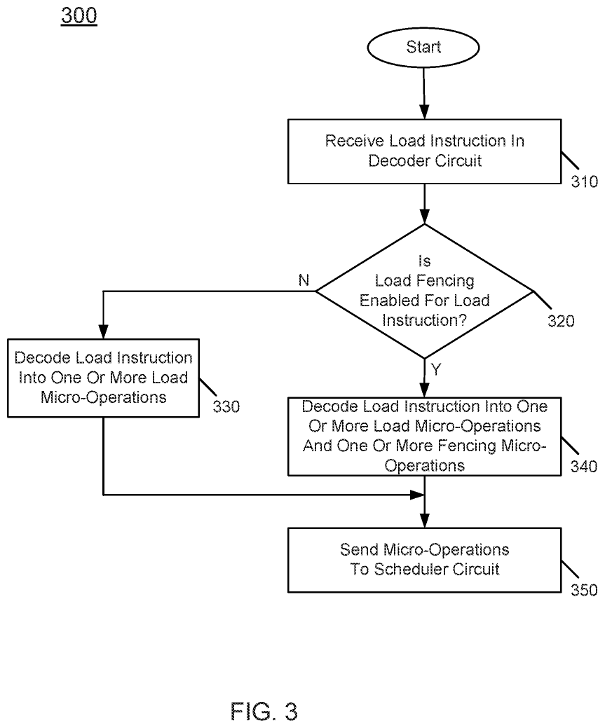

Referring now to FIG. 3, shown is a flow diagram of a method in accordance with an embodiment. As shown in FIG. 3, method 300 may be performed by a decode circuit of a processor. As such, method 300 may be performed by hardware circuitry, firmware, software and/or combinations thereof. More particularly, method 300 is a method for decoding a load instruction and providing fencing protection, e.g., by way of hardware load hardening as described herein. In one particular embodiment, hardware circuitry within decode circuit 105 (including control circuit 107 and decoder 106) of FIG. 1B may perform method 300.

As illustrated, method 300 begins by receiving a load instruction in the decoder circuit (block 310). Such load instruction may be received from an instruction fetch circuit or so forth. Understand that this load instruction, which may be executed to load an operand from memory into a destination register, may be speculatively executed. For example, the load instruction may be sent to the decode circuit as a result of a branch prediction, which predicts a given branch instruction to be taken or not taken, resulting in a path of execution that includes this load instruction.

In any event, control next passes to diamond 320 where it is determined whether load fencing is enabled for this load instruction. Different mechanisms may be implemented to determine whether hardware load hardening including load fencing is enabled. In one embodiment, this determination may be by way of a control or configuration register setting. In other cases, fine-grained control, such as by way of a hint provided with the load instruction, may identify the load fencing enabling. If no load fencing is enabled, control passes to block 330 where the decode circuit may decode the load instruction into one or more load micro-operations. Finally, control passes to block 350 where this one or more load μops may be sent to a scheduler circuit, details of which are described further below.

Still with reference to FIG. 3, if instead it is determined that load fencing is enabled, control passes to block 340. At block 340 the decode circuit may decode the load instruction into one or more load μops. In addition, the decode circuit may further decode this load instruction into one or more fencing μops. As will be described further herein, these fencing μops may be used prevent speculative access to the loaded data until it is non-speculative. In this way, protection is provided against speculative side channel attacks. Then at block 350, these decoded μops are sent to the scheduler circuit. Understand while shown at this high level in the embodiment of FIG. 3, many variations and alternatives are possible.

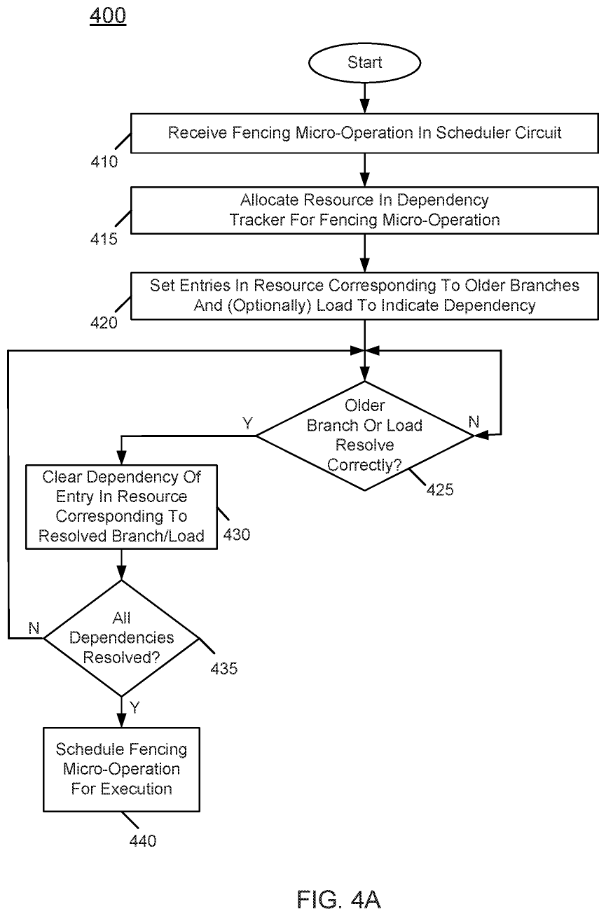

Referring now to FIGS. 4A-4B, shown are flow diagrams of methods in accordance with another embodiment. More specifically, these methods relate to scheduling of μops by a scheduler circuit as described herein. As such, these methods may be performed by a scheduler circuit implemented with hardware circuitry, firmware, software and/or combinations thereof. In one particular embodiment, hardware circuitry within scheduler circuit 110 (including control circuit 112 and dependency matrix 115) of FIG. 1B may perform methods 400 and 450.

As illustrated, method 400 begins by receiving a fencing μop in a scheduler circuit (block 410) In an embodiment, this scheduler circuit may include a reservation station and a dependency tracker such as a dependency matrix, details of which are described further herein. In response to this fencing μop, the scheduler circuit may allocate a resource for the fencing μop in the tracker (block 415). In the example of a dependency matrix, the resource may be a row that is allocated for this fencing μop. Next at block 420 entries in this resource corresponding to older branches may be set to indicate dependency on such older instructions. In addition, in the case of a load instruction that triggers the generation of the fencing μop, an entry in the resource corresponding to the load also may be set. Continuing with the example of a dependency matrix, each entry within the row corresponding to an older branch or the load may be set to a value of 1 to indicate dependency.

Still referring to FIG. 4A, next it may be determined as instructions execute whether one of these older branches or loads has resolved correctly (diamond 425). When it is determined that an older branch or load is correctly resolved, control passes to block 430 where the entry in resource (for the fencing μop) corresponding to the resolved branch/load is reset to clear the dependency on this older branch/load. Next it may be determined at diamond 435 whether all dependencies ahead of the fencing μop have been resolved. If not, control passes back to diamond 425. When it is determined that all dependencies have been resolved (earlier branches and load), control passes to block 440 where the fencing μop may be scheduled for execution. In some embodiments, this fencing μop may be executed as no operation. In any case at this point the protected register is now non-speculative and can be accessed by consumers. Understand while shown at this high level in the embodiment of FIG. 4A, many variations and alternatives are possible.

Referring now to FIG. 4B, shown is a scheduler circuit method for handling consumers of a hardened register in accordance with an embodiment. As illustrated, method 450 begins by receiving a consumer μop in the scheduler circuit (block 460) In response to this consumer μop (which in some cases may be multiple μops), the scheduler circuit may allocate a resource for it in the tracker (block 465), e.g., a row in a dependency matrix. Next at block 470 the entry in this resource corresponding to an earlier fencing μop that protects the register may be set to indicate dependency on this μop.

Still referring to FIG. 4B, next it may be determined as instructions execute whether the fencing μop is ready to execute, in that all dependencies for this μop have cleared (diamond 475). If not, control loops back on this determination. When it is determined that the fencing μop is ready for execution, control passes to block 480, where the dependency on the fencing μop may be cleared in the resource for the consumer μop. As such, control may next pass to block 490 where the consumer μop may be scheduled for execution, which can now access the now non-speculative register contents. Understand while shown at this high level in the embodiment of FIG. 4B, many variations and alternatives are possible.

Thus embodiments may implement HLH with a load fencing μop to achieve a delay at destination strategy for HLH, without tracking the age of data origin. To this end, a decoder circuit may add a fencing μop to fence the destination register of the load. In one implementation, a basic fencing μop scheme may occur by decoding as follows:
Consider a load: dst←ld x, which can be decoded into one more fencing μops having the code, mov_{br}:

tmp←ld x

dst←mov_{br} tmp

Note that this fencing μop mov_{br} has the same destination register as the load. Hence a direct consumer of the load now has a data dependency on the fencing μop, instead of the load. Meanwhile, the fencing μop has a data dependency on the load as well all previous branches, meaning that the fencing μop can only be dispatched if the load writes back data and all previous branches have resolved correctly. This is equivalent to delaying the dispatch of the fencing μop until the load is non-speculative. The execution of the fencing μop is equivalent to a move instruction that moves the temporary destination register of the load. While a branch instruction typically does not have a destination register, data dependency tracking mechanisms in the RS can be used to add a fake data dependency on older branch instructions.

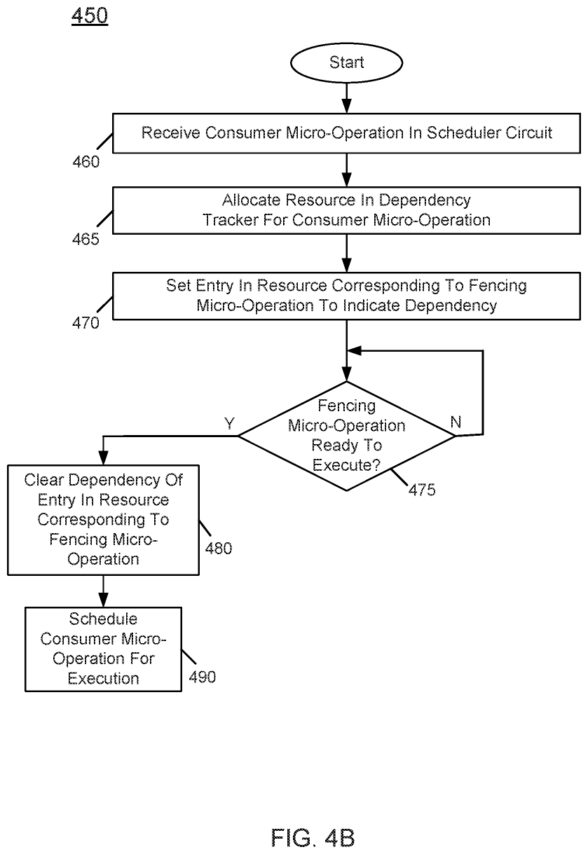

In one embodiment, a RS may use a dependency matrix to track the data dependency on the inflight μops. Referring to FIGS. 5A-5C, shown are representative dependency structures in a scheduler circuit and their operation in accordance with various situations for different implementations of fencing as described herein.

Referring first to FIG. 5A, shown is a dependency matrix 500 that may be formed as a table. Dependency matrix 500 is shown to include a plurality of rows and a plurality of columns, representative row 510 and representative column 520 identified in FIG. 5A. Dependency matrix 500 may have one row and one column for each μop in the RS. If the entry(i, j) in the matrix is set to 1, then the μop belonging to row i is dependent on the μop belonging to column j (i.e., one of the sources of the μop belonging to row i is produced by the μop belonging to column j). For a given row, if all the entries in the row are 0, the μop is ready to dispatch.

Referring now to FIG. 5B, shown is an illustration of dependency matrix 500 that is leveraged to implement the fencing μop. When the fencing μop allocates a row in dependency matrix 500, it sets all the bits of columns corresponding to a branch instruction, as well as the column corresponding to the load. Since a μop is always allocated in program order, this is equivalent to adding a data dependency on all previous branches. When a branch instruction is resolved correctly, it clears the column belonging to it. The implementation of the fencing μop is not specific to use of a dependency matrix, and any mechanism used by a RS to track data dependency can implement the fake data dependency on the branch instruction.

In some cases, a fencing μop can be treated as a micro-fused μop with the load that is unfused in the RS when allocating RS resources.

In other embodiments a fencing μop can be optimized to improve performance, as the fencing μop does not have to depend on the load to fence the destination register of the load. An optimized μops for the load is shown below:

dst←ld x

mov_{br}

In particular, the fencing μop only has a data dependency on all previous branches, and does not have a destination register, hence does not actually write back. In addition, the fencing μop may be optimized to have zero cycle execution latency, similar to a no operation (nop). Although the fencing μop does not have a logical destination register, the same physical destination register as the load may still be assigned to ensure a direct consumer of load also has data dependency on the fencing μop. When a direct consumer of the load is allocated in the RS and the dependency bits in the dependency matrix are generated, it will thus have a match of its source registers to the destination register of the fencing μop as well and will set the dependency bit belonging to the column of the fencing μop. In this way, a data dependency for the direct consumer of a load on the fencing μop is implicitly created, which saves the latency to wake up the direct consumers of the load when the load is ready. Moreover, compared with the scheme without optimization, the fencing μop will occupy RS resources for a smaller amount of time and physical register resources are saved.

Consider the example below with a load that loads data into register r1 and an add instruction which has r1 as its source operand. FIG. 5C shows how dependency matrix 500 and a destination register array 550 are set properly.

r1←ld x

r2←add r1, 1

As shown, the load μop is assigned to a first destination register, R1 in destination register array 550. The add μop is shown to be dependent both on the load μop and the fencing μop and is assigned a second destination register, R2, in destination register array 515. And in turn, the fencing μop is dependent on all prior branches and is assigned the same first register, R1, in destination register array 550.

As another optimization, a load that is micro-fused with an op μop, may be turned into a fencing μop by adding a data dependency on all previous branches, similar to implementation of the fencing μop.

To further reduce the performance overhead of the load fencing-based HLH, one or more software interfaces may be provided to selectively enable load fencing. In one embodiment, load fencing can be enabled/disabled selectively by enabling/disabling HLH mode. In particular, in supervisor mode, HLH mode can be enabled/disabled by writing HLH mode enable bits (one for user mode, one for supervisor mode) in a speculation control model specific register (MSR). Embodiments may also provide a software interface that allows enabling/disabling HLH mode in the user mode by setting/clearing a bit in the EFLAGS register.

In yet other cases, an alternative software interface is to use a prefix to an instruction (e.g., a byte) as a hint to indicate whether a load is to be hardened or not. A fencing μop is inserted to the load only if the load is to be hardened. The semantics of the hint could be either indicating loads are not to be hardened (i.e., passlist approach), or indicating load are to be hardened (i.e., blocklist approach).

As described above, in some cases one or more ISA instructions can be provided to control fencing a particular register, which does not have to be associated with a load. Similar to the fencing μop, there may be multiple versions of such fencing instruction. In one implementation, a basic fencing instruction may take the form of:

dst←mov_{br} src

which takes a source register (src) as an operand and moves the source register to a destination register (dst) when all previous branches are correctly resolved.
In another implementation, an optimized fencing instruction may take the form of:

mov_{br} src

which takes a source register as an operand but does not have a destination register. Implementation wise, this instruction uses the source register as an implicit destination register, in order to ensure younger instructions that consume the source register as an operand will have a data dependency on the fencing instruction as well. Similarly, it also has a data dependency on all previous branches.

In some cases, instead of having the fencing μop dependent on all previous branches, it could also be made to depend on a subset of previous branches, based on the threat model. For example, if only conditional branches or indirect branches are of concern, the fencing μop may be made to depend on all previous conditional branches or indirect branches. In some cases, a scheduler circuit may control behavior to fence against the latest branch before a fencing μop, in which case the fencing μop only depends on the youngest branch before it.

While described with these particular implementations, understand that variations and alternatives are possible.

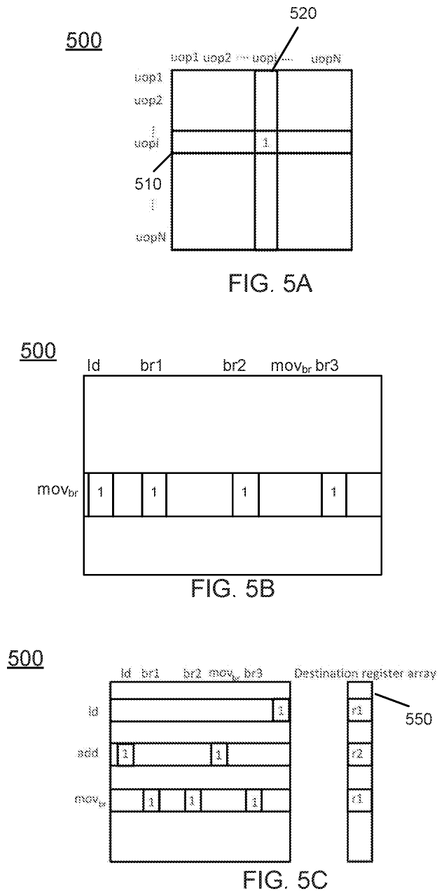

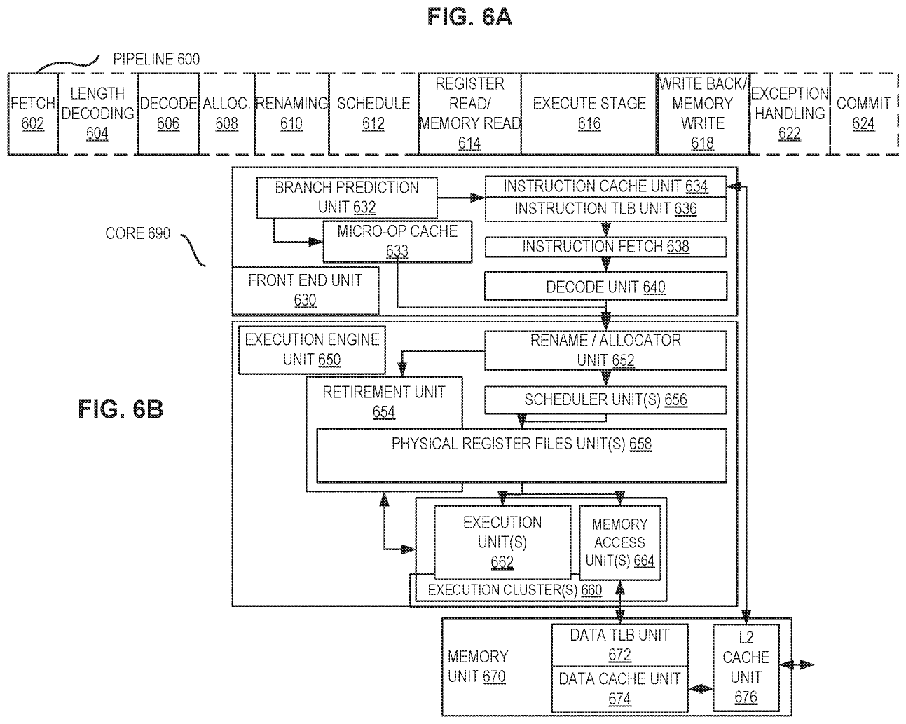

Embodiments may be used in many different processor implementations. FIG. 6A is a block diagram illustrating both an exemplary in-order pipeline and an exemplary register renaming, out-of-order issue/execution pipeline according to embodiments of the invention. FIG. 6B is a block diagram illustrating both an exemplary embodiment of an in-order architecture core and an exemplary register renaming, out-of-order issue/execution architecture core to be included in a processor according to embodiments of the invention. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front-end unit 630 coupled to an execution engine unit 650, and both are coupled to a memory unit 670. Note that core 690 may be a more detailed view of cores 100 described above in FIGS. 1A and 1B. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like. For example, as explained above, core 690 may be any member of a set containing: general-purpose processors, server processors or processing elements for use in a server-environment, coprocessors (e.g., security coprocessors) high-throughput MIC processors, GPGPU's, accelerators (such as, e.g., graphics accelerators or digital signal processing (DSP) units, cryptographic accelerators, fixed function accelerators, machine learning accelerators, networking accelerators, or computer vision accelerators), field programmable gate arrays, or any other processor or processing device.

The front-end unit 630 includes a branch prediction unit 632 coupled to a micro-op cache 633 and an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions, including fencing μops as described herein. The decode unit 640 thus may be one implementation of decode circuit 105 of FIG. 1B. The micro-operations, micro-code entry points, microinstructions, etc. may be stored in at least the micro-op cache 633. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front-end unit 630). The micro-op cache 633 and the decode unit 640 are coupled to a rename/allocator unit 652 in the execution engine unit 650. In various embodiments, a micro-op cache such as 633 may also or instead be referred to as an op-cache, u-op cache, uop-cache, or μop-cache; and micro-operations may be referred to as micro-ops, u-ops, uops, and μops.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. These schedulers may protect register contents using techniques described herein. The scheduler unit(s) 656 thus may be one implementation of scheduler circuit 110 of FIG. 1B. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a write mask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 5) the physical register file(s) unit(s) 658 and the memory unit 670 perform the register read/memory read stage 614; the execution cluster 660 perform the execute stage 616; 6) the memory unit 670 and the physical register file(s) unit(s) 658 perform the write back/memory write stage 618; 7) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif., IBM's “Power” instruction set, or any other instruction set, including both RISC and CISC instruction sets), including the instruction(s) described herein. In one embodiment, the core 690 includes logic to support a packed data instruction set extension (e.g., AVX, AVX2, AVX-512), thereby allowing the operations used by many multimedia applications to be performed using packed data.

It should be understood that the core may support multithreading (executing two or more parallel sets of operations or threads), and may do so in a variety of ways including time sliced multithreading, SMT (e.g., a single physical core provides a logical core for each of the threads that physical core is simultaneously multithreading), or a combination thereof (e.g., time sliced fetching and decoding, and SMT thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 634/674 and a shared L2 cache unit 676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache(s) may be external to the core and/or the processor.

### Exemplary Processor Architectures

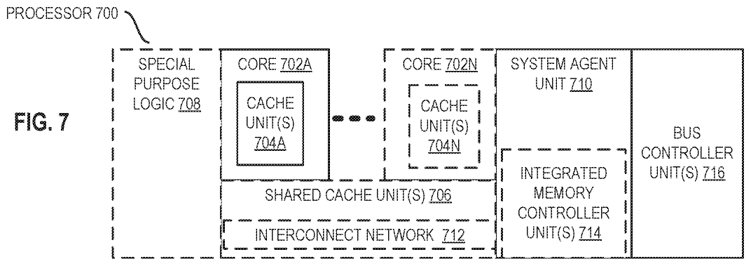

FIG. 7 is a block diagram of a processor 700 that may have more than one core, may have an integrated memory controller, and may have integrated graphics according to embodiments of the invention. The solid lined boxes in FIG. 7 illustrate a processor 700 with a single core 702A, a system agent 710, a set of one or more bus controller units 716, while the optional addition of the dashed lined boxes illustrates an alternative processor 700 with multiple cores 702A-N, a set of one or more integrated memory controller unit(s) 714 in the system agent unit 710, and special purpose logic 708.

Thus, different implementations of the processor 700 may include: 1) a CPU with the special purpose logic 708 being integrated graphics and/or scientific (throughput) logic (which may include one or more cores), and the cores 702A-N being one or more general purpose cores (e.g., general purpose in-order cores, general purpose out-of-order cores, a combination of the two); 2) a coprocessor with the cores 702A-N being a large number of special purpose cores intended primarily for graphics and/or scientific (throughput); 3) a coprocessor with the cores 702A-N being a large number of general purpose in-order cores; and 4) the cores 702A-N representing any number of disaggregated cores with a separate input/output (I/O) block. Thus, the processor 700 may be a general-purpose processors, server processors or processing elements for use in a server-environment, coprocessors (e.g., security coprocessors) high-throughput MIC processors, GPGPU's, accelerators (such as, e.g., graphics accelerators or digital signal processing (DSP) units, cryptographic accelerators, fixed function accelerators, machine learning accelerators, networking accelerators, or computer vision accelerators), field programmable gate arrays, or any other processor or processing device. The processor may be implemented on one or more chips. The processor 700 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 706, and external memory (not shown) coupled to the set of integrated memory controller units 714. The set of shared cache units 706 may include one or more mid-level caches, such as level 2 (L2), level 3 (L3), level 4 (L4), or other levels of cache, a last level cache (LLC), and/or combinations thereof. While in one embodiment a ring-based interconnect unit 712 interconnects the integrated graphics logic 708 (integrated graphics logic 708 is an example of and is also referred to herein as special purpose logic), the set of shared cache units 706, and the system agent unit 710/integrated memory controller unit(s) 714, alternative embodiments may use any number of well-known techniques for interconnecting such units. In one embodiment, coherency is maintained between one or more cache units 706 and cores 702-A-N.

In some embodiments, one or more of the cores 702A-N are capable of multi-threading. The system agent 710 includes those components coordinating and operating cores 702A-N. The system agent unit 710 may include for example a power control unit (PCU) and a display unit. The PCU may be or include logic and components needed for regulating the power state of the cores 702A-N and the integrated graphics logic 708. The display unit is for driving one or more externally connected displays.

The cores 702A-N may be homogenous or heterogeneous in terms of architecture instruction set; that is, two or more of the cores 702A-N may be capable of execution the same instruction set, while others may be capable of executing only a subset of that instruction set or a different instruction set.

### Exemplary Computer Architectures

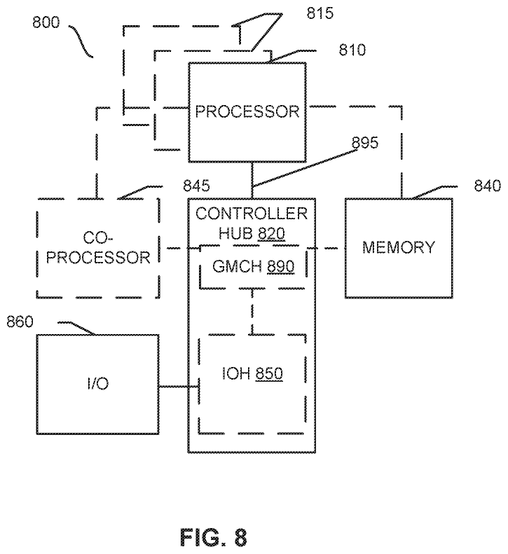

FIGS. 8-11 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), general-purpose processors, server processors or processing elements for use in a server-environment, coprocessors (e.g., security coprocessors) high-throughput MIC processors, GPGPU's, accelerators (such as, e.g., graphics accelerators, cryptographic accelerators, fixed function accelerators, machine learning accelerators, networking accelerators, or computer vision accelerators), field programmable gate arrays, or any other processor or processing device, graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 8, shown is a block diagram of a system 800 in accordance with one embodiment of the present invention. The system 800 may include one or more processors 810, 815, which are coupled to a controller hub 820. In one embodiment, the controller hub 820 includes a graphics memory controller hub (GMCH) 890 and an Input/Output Hub (IOH) 850 (which may be on separate chips); the GMCH 890 includes memory and graphics controllers to which are coupled memory 840 and a coprocessor 845; the IOH 850 couples I/O devices 860 to the GMCH 890. Alternatively, one or both of the memory and graphics controllers are integrated within the processor (as described herein), the memory 840 and the coprocessor 845 are coupled directly to the processor 810, and the controller hub 820 in a single chip with the IOH 850.

The optional nature of additional processors 815 is denoted in FIG. 8 with broken lines. Each processor 810, 815 may include one or more of the processing cores described herein and may be some version of the processor 700.

The memory 840 may be, for example, dynamic random-access memory (DRAM), phase change memory (PCM), or a combination of the two. For at least one embodiment, the controller hub 820 communicates with the processor(s) 810, 815 via a multi-drop bus, such as a front-side bus (FSB), point-to-point interface such as QuickPath Interconnect (QPI), or similar connection 895.

In one embodiment, the coprocessor 845 is a special-purpose processor (including, e.g., general-purpose processors, server processors or processing elements for use in a server-environment, coprocessors such as security coprocessors, high-throughput MIC processors, GPGPU's, accelerators, such as, e.g., graphics accelerators or digital signal processing (DSP) units, cryptographic accelerators, fixed function accelerators, machine learning accelerators, networking accelerators, or computer vision accelerators), field programmable gate arrays, or any other processor or processing device). In one embodiment, controller hub 820 may include an integrated graphics accelerator.

There can be a variety of differences between the physical resources 810, 815 in terms of a spectrum of metrics of merit including architectural, microarchitectural, thermal, power consumption characteristics, and the like.

In one embodiment, the processor 810 executes instructions that control data processing operations of a general type. Embedded within the instructions may be coprocessor instructions. The processor 810 recognizes these coprocessor instructions as being of a type that should be executed by the attached coprocessor 845. Accordingly, the processor 810 issues these coprocessor instructions (or control signals representing coprocessor instructions) on a coprocessor bus or other interconnect, to coprocessor 845. Coprocessor(s) 845 accept and execute the received coprocessor instructions.

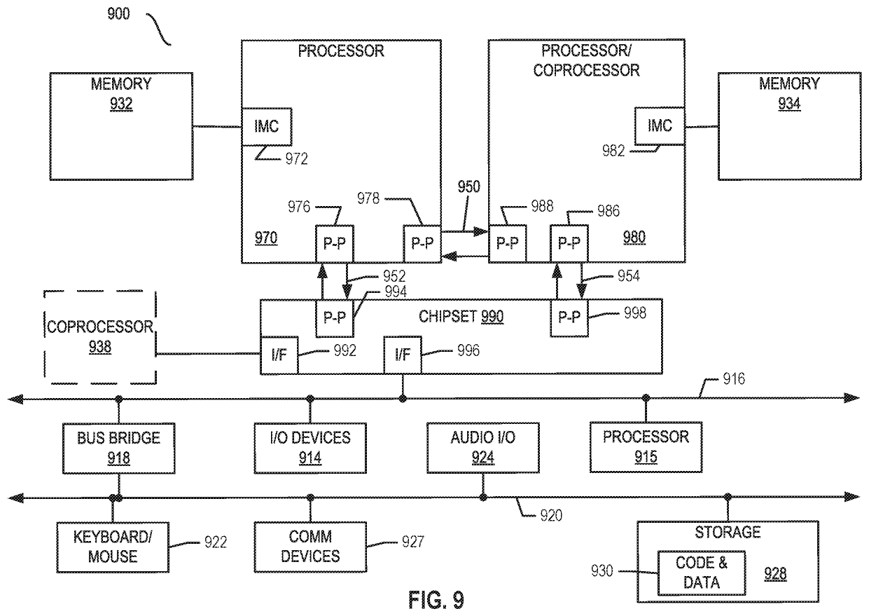

Referring now to FIG. 9, shown is a block diagram of a first more specific exemplary system 900 in accordance with an embodiment of the present invention. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 700. In one embodiment of the invention, processors 970 and 980 are respectively processors 810 and 815, while coprocessor 938 is coprocessor 845. In another embodiment, processors 970 and 980 are respectively processor 810 coprocessor 845.

Processors 970 and 980 are shown including integrated memory controller (IMC) units 972 and 982, respectively. Processor 970 also includes as part of its bus controller unit's point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 992. In one embodiment, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present invention is not so limited.

As shown in FIG. 9, various I/O devices 914 may be coupled to first bus 916, along with a bus bridge 918 which couples first bus 916 to a second bus 920. In one embodiment, one or more additional processor(s) 915, such as general-purpose processors, server processors or processing elements for use in a server-environment, coprocessors (e.g., security coprocessors) high-throughput MIC processors, GPGPU's, accelerators (such as, e.g., graphics accelerators or digital signal processing (DSP) units, cryptographic accelerators, fixed function accelerators, machine learning accelerators, networking accelerators, or computer vision accelerators), field programmable gate arrays, or any other processor or processing device, are coupled to first bus 916. In one embodiment, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

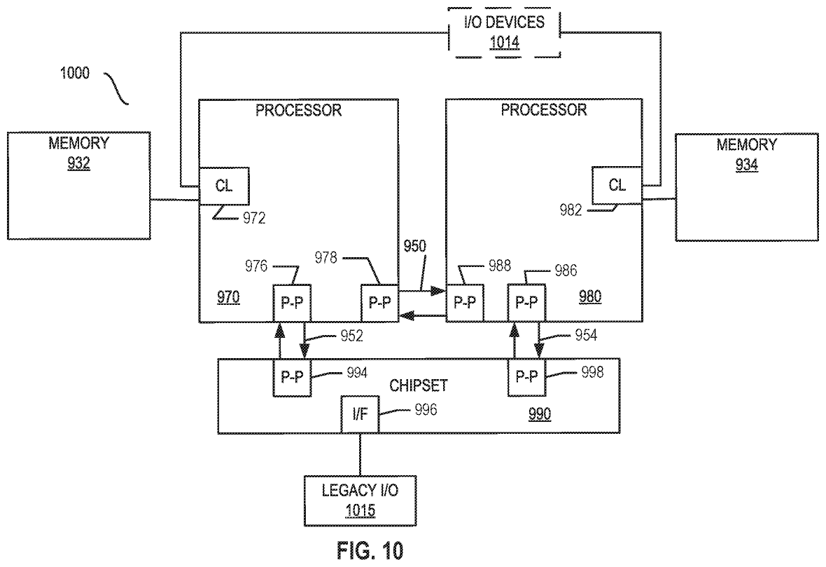

Referring now to FIG. 10, shown is a block diagram of a second more specific exemplary system 1000 in accordance with an embodiment of the present invention. Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 970, 980 may include integrated memory and I/O control logic (“CL”) 972 and 982, respectively. Thus, the CL 972, 982 include integrated memory controller units and include I/O control logic. FIG. 10 illustrates that not only are the memories 932, 934 coupled to the CL 972, 982, but also that I/O devices 1014 are also coupled to the control logic 972, 982. Legacy I/O devices 1015 are coupled to the chipset 990.

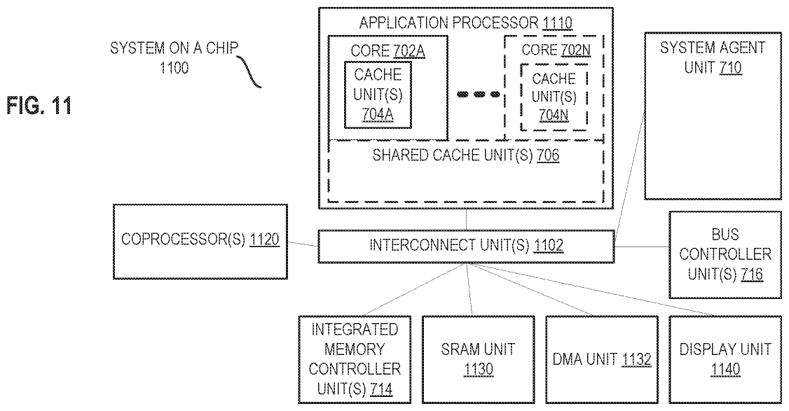

Referring now to FIG. 11, shown is a block diagram of a SoC 1100 in accordance with an embodiment of the present invention. Similar elements in FIG. 7 bear like reference numerals. Also, dashed lined boxes are optional features on more advanced SoCs. In FIG. 11, an interconnect unit(s) 1102 is coupled to: an application processor 1110 which includes a set of one or more cores 702A-N, which include cache units 704A-N, and shared cache unit(s) 706; a system agent unit 710; a bus controller unit(s) 716; an integrated memory controller unit(s) 714; a set or one or more coprocessors 1120 which may include integrated graphics logic, an image processor, an audio processor, and a video processor, general-purpose processors, server processors or processing elements for use in a server-environment, security coprocessors, high-throughput MIC processors, GPGPU's, accelerators (such as, e.g., graphics accelerators or digital signal processing (DSP) units, cryptographic accelerators, fixed function accelerators, machine learning accelerators, networking accelerators, or computer vision accelerators), field programmable gate arrays, or any other processor or processing device; an static random access memory (SRAM) unit 1130; a direct memory access (DMA) unit 1132; and a display unit 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, including, e.g., general-purpose processors, server processors or processing elements for use in a server-environment, coprocessors (e.g., security coprocessors) high-throughput MIC processors, GPGPU's, accelerators (such as, e.g., graphics accelerators or digital signal processing (DSP) units, cryptographic accelerators, fixed function accelerators, machine learning accelerators, networking accelerators, or computer vision accelerators), field programmable gate arrays, or any other processor or processing device, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Instructions to be executed by a processor core according to embodiments of the invention may be embodied in a “generic vector friendly instruction format” which is detailed below. In other embodiments, such a format is not utilized and another instruction format is used, however, the description below of the write-mask registers, various data transformations (swizzle, broadcast, etc.), addressing, etc. is generally applicable to the description of the embodiments of the instruction(s) above. Additionally, exemplary systems, architectures, and pipelines are detailed below. Instructions may be executed on such systems, architectures, and pipelines, but are not limited to those detailed.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

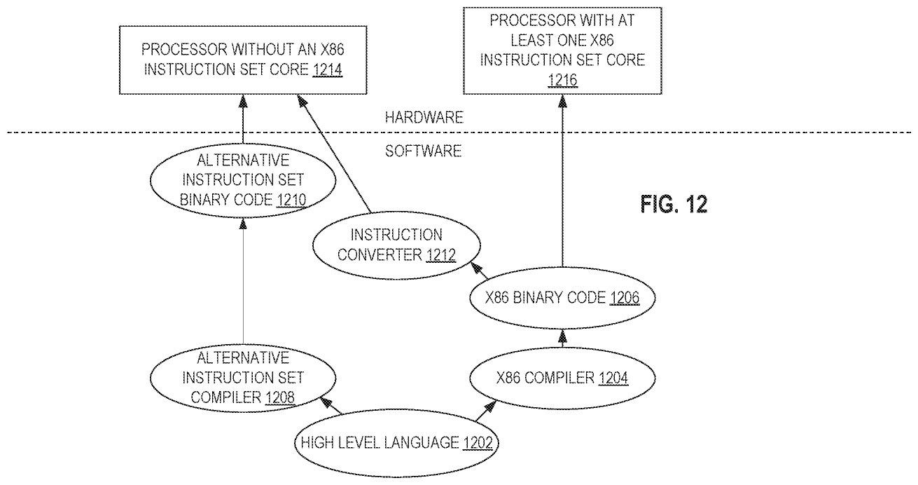

FIG. 12 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 12 shows a program in a high-level language 1202 may be compiled using an x86 compiler 1204 to generate x86 binary code 1206 that may be natively executed by a processor with at least one x86 instruction set core 1216. The processor with at least one x86 instruction set core 1216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1204 represents a compiler that is operable to generate x86 binary code 1206 (e.g., object code) that can, with or without additional linkage processing, be executed on the processor with at least one x86 instruction set core 1216. Similarly, FIG. 12 shows the program in the high level language 1202 may be compiled using an alternative instruction set compiler 1208 to generate alternative instruction set binary code 1210 that may be natively executed by a processor without at least one x86 instruction set core 1214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1212 is used to convert the x86 binary code 1206 into code that may be natively executed by the processor without an x86 instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have an x86 instruction set processor or core to execute the x86 binary code 1206.

Operations in flow diagrams may have been described with reference to exemplary embodiments of other figures. However, it should be understood that the operations of the flow diagrams may be performed by embodiments of the invention other than those discussed with reference to other figures, and the embodiments of the invention discussed with reference to other figures may perform operations different than those discussed with reference to flow diagrams. Furthermore, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

The following examples pertain to further embodiments.

In one example, a processor includes: a decode circuit to decode a load instruction that is to load an operand to a destination register, the decode circuit to generate at least one fencing μop associated with the destination register; and a scheduler circuit coupled to the decode circuit. The scheduler circuit is to prevent speculative execution of one or more instructions that consume the operand in response to the at least one fencing μop.

In an example, the decode circuit further is to decode the load instruction into one or more load μops and generate the at least one fencing μop in response to the load instruction.

In an example, the scheduler circuit is to allocate a resource in a dependency structure for the at least one fencing μop.

In an example, the dependency structure comprises a dependency matrix and the resource comprises a row of the dependency matrix including a plurality of entries.

In an example, the load instruction identifies the destination register, and the decode circuit is to decode the load instruction into a first load μop to load the operand to a second register, the at least one fencing μop comprising a μop to move the operand from the second register to the destination register.

In an example, the scheduler circuit is to make the at least one fencing μop dependent on one or more prior branches.

In an example, the processor further comprises a configuration register to store an enable indicator for load hardening, where when the enable indicator is disabled, the decode circuit is to not generate the at least one fencing μop.

In an example, the load instruction comprises a hint to indicate to the decode circuit to generate the at least one fencing μop.

In an example, the at least one fencing μop is to prevent a transient execution attack.

In another example, a method comprises: receiving, in a scheduler circuit of a processor, a fencing μop that identifies a register to be prevented from being accessed speculatively; speculatively obtaining an operand to be stored in the register; and preventing the operand stored in the register from being accessed by at least one consumer until at least one branch operation prior to the fencing μop correctly resolves.

In an example, the method further comprises receiving the fencing μop from a decode circuit, the decode circuit generating the fencing μop in response to a fencing instruction that identifies the register.

In an example, the method further comprises receiving the fencing μop from a decode circuit, the decode circuit generating the fencing μop in response to a load instruction that identifies the register.

In an example, the method further comprises the decode circuit generating the fencing μop in response to a hint of the load instruction that specifies speculative load hardening.

In an example, the method further comprises scheduling the fencing μop for execution after the operand is loaded into the register and one or more prior branch instructions correctly resolved.

In an example, the method further comprises receiving the fencing μop comprising a move μop to move the operand from a second register to the register.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In yet another example, a system comprises a processor and a system memory coupled to the processor. The processor may include at least one core. The at least one core comprises: a decode circuit to decode a first user-level instruction that is to prevent an operand stored in a first register from being speculatively accessed, where the decode circuit is to generate at least one fencing μop in response to the first user-level instruction; and a scheduler circuit coupled to the decode circuit, where the scheduler circuit is, in response to the at least one fencing μop, to prevent speculative access of the operand stored in the first register by one or more instructions that consume the operand.

In an example, the at least one core further comprises: a branch predictor to predict a direction of a branch instruction; and a pipeline circuit to speculatively load the operand into the first register in response to the direction prediction.

In an example, when the direction prediction resolves correctly, the scheduler circuit is to enable the one or more instructions to access the operand.

In an example, the processor further comprises a configuration register to store an enable indicator for load hardening, where when the enable indicator is disabled, the decode circuit is to not generate the at least one fencing μop.

In an example, the at least one fencing μop is to prevent a transient execution attack.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor comprising:
a decode circuit to decode a load instruction that is to load an operand to a destination register, the decode circuit to generate at least one fencing micro-operation (μop) associated with the destination register; and
a scheduler circuit coupled to the decode circuit, wherein the scheduler circuit is to prevent speculative execution of one or more instructions that consume the operand in response to the at least one fencing μop.

2. The processor of claim 1, wherein the decode circuit further is to decode the load instruction into one or more load μops and generate the at least one fencing μop in response to the load instruction.

3. The processor of claim 1, wherein the scheduler circuit is to allocate a resource in a dependency structure for the at least one fencing μop.

4. The processor of claim 3, wherein the dependency structure comprises a dependency matrix and the resource comprises a row of the dependency matrix including a plurality of entries.

5. The processor of claim 1, wherein the load instruction identifies the destination register, and the decode circuit is to decode the load instruction into a first load μop to load the operand to a second register, the at least one fencing μop comprising a μop to move the operand from the second register to the destination register.

6. The processor of claim 1, wherein the scheduler circuit is to make the at least one fencing μop dependent on one or more prior branches.

7. The processor of claim 1, further comprising a configuration register to store an enable indicator for load hardening, wherein when the enable indicator is disabled, the decode circuit is to not generate the at least one fencing μop.

8. The processor of claim 1, wherein the load instruction comprises a hint to indicate to the decode circuit to generate the at least one fencing μop.

9. The processor of claim 1, wherein the at least one fencing μop is to prevent a transient execution attack.

10. At least one computer readable storage medium having stored thereon instructions, which if performed by a machine cause the machine to perform a method comprising:
receiving, in a scheduler circuit of a processor, a fencing micro-operation (μop) that identifies a register to be prevented from being accessed speculatively;
speculatively obtaining an operand to be stored in the register; and
preventing the operand stored in the register from being accessed by at least one consumer until at least one branch operation prior to the fencing μop correctly resolves.

11. The at least one computer readable storage of claim 10, wherein the method further comprises receiving the fencing μop from a decode circuit, the decode circuit generating the fencing μop in response to a fencing instruction that identifies the register.

12. The at least one computer readable storage of claim 10, wherein the method further comprises receiving the fencing μop from a decode circuit, the decode circuit generating the fencing μop in response to a load instruction that identifies the register.

13. The at least one computer readable storage of claim 12, wherein the method further comprises the decode circuit generating the fencing μop in response to a hint of the load instruction that specifies speculative load hardening.

14. The at least one computer readable storage of claim 10, wherein the method further comprises scheduling the fencing μop for execution after the operand is loaded into the register and one or more prior branch instructions correctly resolved.

15. The at least one computer readable storage of claim 10, wherein the method further comprises receiving the fencing μop comprising a move μop to move the operand from a second register to the register.

16. A system comprising:
a processor comprising:
at least one core, the at least one core comprising:
a decode circuit to decode a first user-level instruction that is to prevent an operand stored in a first register from being speculatively accessed, wherein the decode circuit is to generate at least one fencing micro-operation (μop) in response to the first user-level instruction; and
a scheduler circuit coupled to the decode circuit, wherein the scheduler circuit is, in response to the at least one fencing μop, to prevent speculative access of the operand stored in the first register by one or more instructions that consume the operand; and
a system memory coupled to the processor.

17. The system of claim 16, wherein the at least one core further comprises:
a branch predictor to predict a direction of a branch instruction; and
a pipeline circuit to speculatively load the operand into the first register in response to the direction prediction.

18. The system of claim 17, wherein when the direction prediction resolves correctly, the scheduler circuit is to enable the one or more instructions to access the operand.

19. The system of claim 16, wherein the processor further comprises a configuration register to store an enable indicator for load hardening, wherein when the enable indicator is disabled, the decode circuit is to not generate the at least one fencing μop.

20. The system of claim 16, wherein the at least one fencing μop is to prevent a transient execution attack.
